(19) United States
(12) Patent Application Publication
(10) Pub. No.: US 2026/0046661 A1
(43) Pub. Date: Feb. 12, 2026

(54) INFORMATION REPORTING METHOD, INFORMATION RECEIVING METHOD, USER-SIDE DEVICE, NETWORK-SIDE DEVICE, AND STORAGE MEDIUM

(71) Applicant: Beijing Xiaomi Mobile Software Co., Ltd., Beijing (CN)

(72) Inventor: Xing YANG, Beijing (CN)

(73) Assignee: Beijing Xiaomi Mobile Software Co., Ltd., Beijing (CN)

(21) Appl. No.: 19/102,021

(22) PCT Filed: Aug. 8, 2022
(86) PCT No.: PCT/CN2022/110935

§ 371 Date: Feb. 7, 2025

(51) Int. Cl. H04W 24/10; H04W 36/00

(52) U.S. Cl. CPC H04W 24/10; H04W 36/0085

(57) ABSTRACT

An information reporting method is provided. The information reporting method includes: obtaining a measurement result by measuring a node; determining to trigger measurement reporting for the measurement result; generating first auxiliary information according to the measurement reporting, wherein the first auxiliary information includes handover tendency information corresponding to the node; and reporting the first auxiliary information to a network-side device.

### CROSS REFERENCE TO RELATED APPLICATIONS

The present disclosure is the U.S. national phase application of International Application No. PCT/CN2022/110935 filed on Aug. 8, 2022, the content of which is incorporated herein by reference in its entirety for all purposes.

### TECHNICAL FIELD

The present disclosure relates to the field of communication technology, in particular, to an information reporting method and apparatus, an information receiving method and apparatus, a user-side device, a network-side device, and a storage medium.

### BACKGROUND

The network-side device can send a handover request to a target node (a target cell or a target relay User Equipment (UE)) based on the measurement report from the user-side device (UE). After the target node completes the confirmation, the network-side device will send a handover command to the user-side device, carrying the configuration information of the target node. After receiving the handover command, the user-side device will initiate a random access process to the target node.

### SUMMARY

According to a first aspect of the present disclosure, an information reporting method is provided. The method is performed by a user-side device, and includes: obtaining a measurement result by measuring a node; determining to trigger measurement reporting for the measurement result; generating first auxiliary information based on the measurement reporting, wherein the first auxiliary information includes handover tendency information corresponding to the node; and reporting the first auxiliary information to a network-side device.

According to a second aspect of the present disclosure, an information receiving method is provided. The method is performed by a network-side device, and includes: receiving first auxiliary information reported by a user-side device, wherein the first auxiliary information includes handover tendency information corresponding to a node.

According to a third aspect of the present disclosure, a user-side device is provided. The user-side device includes: a first processor; and a first memory for storing executable instructions to be executed by the first processor; wherein the first processor is configured to execute the executable instructions to perform the information reporting method described in the first aspect of the present disclosure.

According to a fourth aspect of the present disclosure, a network-side device is provided. The network-side device includes: a second processor; and a second memory for storing executable instructions to be executed by the second processor; wherein the second processor is configured to execute the executable instructions to perform the information receiving method described in the second aspect of the present disclosure.

According to a fifth aspect of the present disclosure, a non-transitory computer storage medium is provided, which stores executable instructions. When the executable instructions are executed by a third processor, the third processor performs the information reporting method described in the first aspect of the present disclosure or the information receiving method described in the second aspect of the present disclosure.

It should be understood that the general description in the above and the detailed description in the following are only exemplary and explanatory, and cannot limit the present disclosure.

### BRIEF DESCRIPTION OF THE DRAWINGS

The above and/or additional aspects and advantages of the present disclosure will become apparent and easily understood from the following description of the embodiments with reference to the drawings.

FIG. 1 is a schematic diagram of a communication system according to one or more embodiments of the present disclosure.

FIG. 2 is a flowchart of an information reporting method according to one or more embodiments of the present disclosure.

FIG. 3 is a flowchart of an information reporting method according to one or more embodiments of the present disclosure.

FIG. 4 is a flowchart of an information reporting method according to one or more embodiments of the present disclosure.

FIG. 5 is a flowchart of an information reporting method according to one or more embodiments of the present disclosure.

FIG. 6 is a flowchart of an information receiving method according to one or more embodiments of the present disclosure.

FIG. 7 is a flowchart of an information receiving method according to one or more embodiments of the present disclosure.

FIG. 8 is a timing diagram of communication between a network-side device and a user-side device according to one or more embodiments of the present disclosure.

FIG. 9 is a block diagram of an information reporting apparatus according to one or more embodiments of the present disclosure.

FIG. 10 is a schematic diagram of a structure of a user-side device according to one or more embodiments of the present disclosure.

FIG. 11 is a schematic diagram of a structure of a network-side device according to one or more embodiments of the present disclosure.

### DETAILED DESCRIPTION

Detailed explanations of exemplary embodiments will be provided herein, with examples being illustrated in the drawings. The same reference numerals in different drawings represent the same or similar elements when the following description refers to the drawings, unless otherwise indicated. The implementations described in the following exemplary embodiments do not represent all implementations consistent with the present disclosure, instead, they are only examples of devices and methods consistent with some aspects of embodiments of the present disclosure as described in the appended claims.

At present, when the network-side device sends the handover request to the target node (target cell or target relay UE), the channel quality between the user-side device and the target node may have deteriorated or the configuration for the measurement reporting event may be unreasonable. If the user-side device fails to trigger the measurement reporting in a timely manner, the handover initiated by the user-side device to the target node may be not successful.

In order to solve the problem of possible failure in the handover initiated by the user-side device to the target node, embodiments of the present disclosure provide an information reporting method.

The environment to which embodiments of the present disclosure are applied will be introduced in the following.

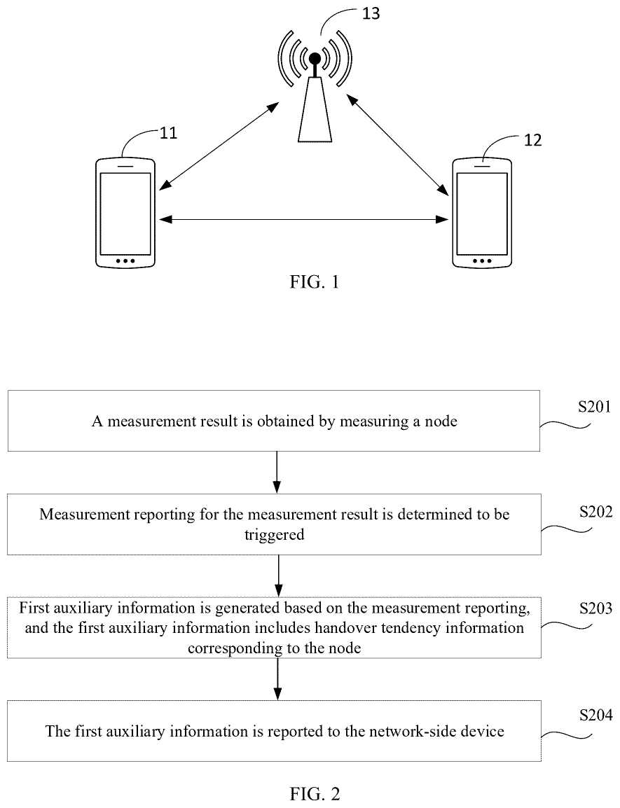

The technical solutions of embodiments of the present disclosure can be applied to various communication systems. FIG. 1 is a schematic diagram of a communication system according to one or more embodiments of the present disclosure. As shown in FIG. 1, a first user-side device 11, a second user-side device 12, and a network-side device 13 are included. Terminals will be used to represent the first user-side device 11 and the second user-side device 12 in the following. In some embodiments, the first user-side device 11 and the second user-side device 12 can communicate through the Sidelink via the PC5 interface. The network-side device 13 can communicate with the terminals through uplink and downlink communication via the air interface (Uu).

In some embodiments, the terminals can be terminal devices such as mobile phones, tablet personal computers, laptop computers, personal digital assistants (PDA), mobile internet devices (MID), wearable devices, smart cars, on-board devices, or robots. It should be noted that in the present disclosure, the specific type of the terminal is not limited.

The network-side device 13 can be a base station, which is a device deployed in an access network to provide the wireless communication functionality for the terminal. The base station can be either the base station in the serving cell of the terminal, or the base station in the cell adjacent to the serving cell of the terminal. The base station can include various forms of macro base stations, micro base stations, relay stations, access points, transmission reception points (TRP), and so on. In systems using different wireless access technologies, the name of the device with the base station functionality may vary. In 5G New Radio (NR) systems, the device with the base station functionality is referred to as gNodeB or gNB. With the evolution of the communication technology, the description of the term “base station” may change. The network-side device can also be a location management function (LMF) entity.

It should be noted that in the wireless communication system shown in FIG. 1, the terminal can directly communicate with the network-side device 13, and the direct connection between the terminal and the network-side device 13 is referred to as a direct link. In some embodiments, the terminal can also communicate indirectly through an indirect connection (Sidelink). That is, the terminal communicates with the network-side device 13 via at least one relay UE, and the indirect connection between the terminal and the network-side device through the at least one relay UE is referred to as an indirect link.

FIG. 2 is a flowchart of an information reporting method according to one or more embodiments of the present disclosure. The method is performed by the first user-side device 11 or the second user-side device 12 shown in FIG. 1. The following explanations will be based on the user-side device. As shown in FIG. 2, the information reporting method includes the following steps.

In step S201, a measurement result is obtained by measuring a node.

It should be noted that the user-side device can communicate with the network-side device via a relay UE, and the user-side device can also directly communicate with the network-side device. In some embodiments, the node can include a cell and/or a relay UE. In some embodiments, the cell can be understood as adjacent cell (a candidate cell) of the user-side device, that is, the network-side device adjacent to the user-side device. In some embodiments, the relay UE is an adjacent relay UE (a candidate relay UE) of the user-side device, that is, the relay UE adjacent to the user-side device.

It should be noted that the measurement result herein is used to indicate the channel quality between the node and the user-side device.

In some embodiments, the network-side device can configure the measurement object for the user-side device, and the configured measurement object is the node that needs to be measured.

In step S202, measurement reporting for the measurement result is determined to be triggered.

In some embodiments, the measurement reporting can be based on event triggering. In some embodiments, when detecting a corresponding event, the user-side device performs the measurement reporting. In some embodiments, the event includes a newly defined event that triggers the measurement reporting in the present disclosure. In some embodiments, the event can include Event X1, Event X2, Event Y1, and Event Y2. In some embodiments, Event X1 and Event X2 are configured for mobility management of the user-side device from an indirect link to a direct link, and Event Y1 and Event Y2 are configured for mobility management of the user-side device from a direct link to an indirect link.

In some embodiments, Event X1 indicates a measurement result of a serving relay UE of the user-side device lower than a first threshold, and a measurement result of a candidate cell of the user-side device higher than a second threshold. Event X2 indicates a measurement result of a serving relay UE of the user-side device lower than a third threshold. Event Y1 indicates a measurement result of a serving cell of the user-side device lower than a first threshold, and a measurement result of a candidate relay UE of the user-side device higher than a second threshold. Event Y2 indicates a measurement result of a candidate relay UE of the user-side device higher than a third threshold. The first threshold, the second threshold, and the third threshold can be configured by the network-side device.

It should be noted that in some embodiments, the serving relay UE is a device that supports the current communication between the user-side device and the network-side device through the indirect link, and the candidate cell can be understood as an adjacent cell that can establish a direct link with the user-side device. In some embodiments, the serving cell is a device that supports the current communication between the user-side device and the network-side device through the direct link, and the candidate relay UE can be understood as a relay UE that can establish an indirect link with the user-side device.

In some embodiments, Event X1 is taken as an example, in the case where the measurement result of the serving relay UE of the user-side device is lower than the first threshold and the measurement result of the candidate cell of the user-side device is higher than the second threshold, the measurement reporting is triggered, and the measurement reporting can include the reporting of the measurement result, the cell identification, and other information of the candidate cell.

In addition, it should be noted that when the measurement reporting is based on the event triggering, the measurement can also be performed on the serving relay UE or the serving cell of the user-side device, to obtain the measurement result of the serving relay UE or the serving cell, so as to determine whether the event in the above embodiments has occurred. The serving relay UE and the serving cell herein can be referred to as serving nodes, correspondingly to the candidate node.

In some embodiments, the measurement reporting can be based on periodic triggering. The cycle for triggering the measurement reporting can be sent by the network-side device or specified in a protocol. For example, if the cycle for triggering the measurement reporting is 1 hour, the user-side device will report the measurement result of the node every hour.

In addition, it should be noted that when the measurement reporting is based on the periodic triggering, the measurement can also be performed on the serving node, to obtain the measurement result of the serving node, so as to measure and determine whether the channel quality between the serving node and the user-side device is better than the channel quality between the candidate node and the user-side device. In some embodiments, in the case where the channel quality corresponding to the serving node is better than the channel quality corresponding to the candidate node, the network-side device will not instruct the user-side device to perform the handover, and the serving node can be continued to be used to support the signal transmission between the user-side device and the network-side device.

In step S203, first auxiliary information is generated based on the measurement reporting, and the first auxiliary information includes handover tendency information corresponding to the node.

In some embodiments, the handover tendency information can include at least one of the following:
a probability of performing handover to the node, and the probability includes either a success probability or a failure probability;
a handover result indication for performing handover to the node, and the handover result indication includes either a success indication or a failure indication;
time information about performing handover to the node, and the time information is configured to indicate a maximum postpone time, a minimum postpone time, or a time range for initiating the handover to the node.

It should be noted that in the case where the probability is the success probability, the handover initiated to a node with higher success probability is more likely to succeed. In the case where the probability is the failure probability, the handover initiated to a node with lower failure probability is more likely to succeed.

It should be noted that the handover initiated to a node with the handover result indication being of the success indication is more likely to succeed than the handover initiated to a node with the handover result indication being of the failure indication.

It should be noted that the maximum postpone time, the minimum postpone time, and the time range can be characterized by a specified duration. In some embodiments, the specified duration is 100 milliseconds. When the specified duration is used to indicate that the handover should be initiated to the node before 100 milliseconds after the first auxiliary information is reported (the description in the following will be provided taking that the time corresponding to the reporting of the first auxiliary information is First Time), the time corresponding to 100 milliseconds behind the First Time represents the maximum postpone time, and [First Time, First Time+100 milliseconds] represents the time range. In some embodiments, the specified duration is 100 milliseconds. When the specified duration is used to indicate that the handover should be initiated to the node after 100 milliseconds after the first auxiliary information is reported, [First Time+100 milliseconds, time1] can represent the time range, where time1 can be any time after the time corresponding to 100 milliseconds after the First Time, and the time corresponding to 100 milliseconds after the First Time represents the minimum postpone time.

In some embodiments, the maximum postpone time, the minimum postpone time, and the time range can be characterized by a specified starting time and a duration. In some embodiments, the specified starting time is the time (hereinafter referred to as Second Time) corresponding to 50 milliseconds after the first auxiliary information is reported. When the duration is 100 milliseconds, it is used to indicate that the handover should be initiated to the node before 100 milliseconds after the Second Time. Then [Second Time, Second Time+100 milliseconds] represents the time range, the time corresponding to 100 milliseconds after the Second Time represents the maximum postpone time, and the Second Time represents the minimum postpone time. It should be noted that the handover initiated to the node before the maximum postpone time, after the minimum postpone time, or within the time range is more likely to succeed. In some embodiments, initiating the handover to the node refers to the user-side device initiating the handover to the target node, where the target node is one of the candidate nodes mentioned in the above.

In some embodiments, the first auxiliary information can also include the measurement result, the node identification, and other information corresponding to the node.

It should be noted that the process of generating the first auxiliary information can refer to the following embodiments, which will not be repeated here.

In step S204, the first auxiliary information is reported to the network-side device.

According to embodiments of the present disclosure, the first auxiliary information includes the handover tendency information configured to indicate successful handover, which is reported to the network-side device, so that the network-side device can quickly determine, based on the handover tendency information in the first auxiliary information, the node handover command to be sent to the user-side device. The node handover command can include the identification of the target node to which the handover is to be performed and/or the time information for performing the handover to the target node, so that the user-side device can perform the handover according to the node handover command, thereby reducing the failure handover probability when the user-side device performs the handover to the target node and avoiding the failure handover.

In some embodiments, in the case where the handover tendency information includes the success probability of performing handover to a node, the network-side device can determine the node with the highest success probability as the target node, and indicate to the user-side device to initiate the handover to the target node.

In some embodiments, in the case where the handover tendency information includes the failure probability of performing handover to a node, the network-side device can determine the node with the lowest failure probability as the target node, and indicate to the user-side device to initiate the handover to the target node.

In some embodiments, in the case where the handover tendency information includes the time information about performing handover to a node, the network-side device can indicate to the user-side device to initiate the handover to the node before the maximum postpone time, after the minimum postpone time, or within the time range.

In some embodiments, in the case where the handover tendency information includes the success probability and the time information about performing handover to a node, the network-side device can indicate to the user-side device to initiate the handover to the node with the highest success probability, and initiate the handover before the maximum postpone time, after the minimum postpone time, or within the time range, which are indicated for this node correspondingly.

It should be noted that the handover tendency information can also be provided in other ways by combining the information such as the probability of performing the handover to the node, the handover result indication for performing the handover to the node, and the time information about performing the handover to the node. Additional embodiments of the present disclosure will not be repeated here.

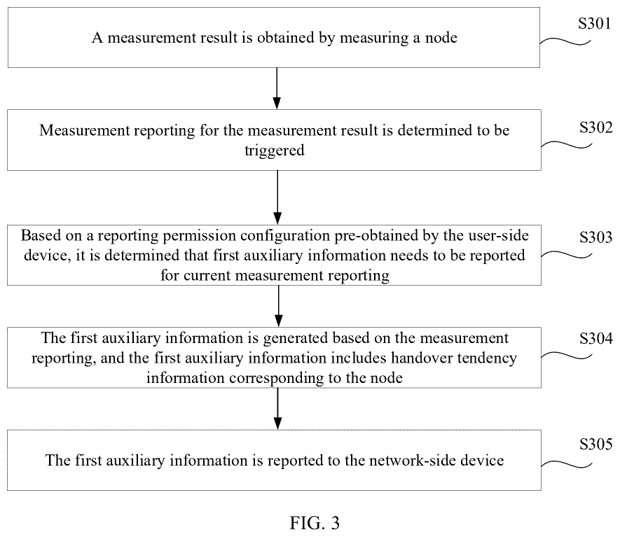

FIG. 3 is a flowchart of an information reporting method according to one or more embodiments of the present disclosure. The method is performed by the user-side device. As shown in FIG. 3, the method includes the following steps.

In step S301, a measurement result is obtained by measuring a node.

In step S302, measurement reporting for the measurement result is determined to be triggered.

In step S303, based on a reporting permission configuration pre-obtained by the user-side device, it is determined that first auxiliary information needs to be reported for current measurement reporting.

In step S304, the first auxiliary information is generated based on the measurement reporting, and the first auxiliary information includes handover tendency information corresponding to the node.

In step S305, the first auxiliary information is reported to the network-side device.

In some embodiments, the implementations of steps S301, S302, S304, and S305 can refer to embodiments mentioned in the above, which will not be repeated here.

For the step S303, the reporting permission configuration is used for the user-side device to determine whether to report the first auxiliary information.

In some embodiments, the reporting permission configuration can be configured by the network-side device and sent to the user-side device.

In this way, the network-side device can configure, according to actual applications, whether to report the first auxiliary information, improving the flexibility of reporting the first auxiliary information in different situations.

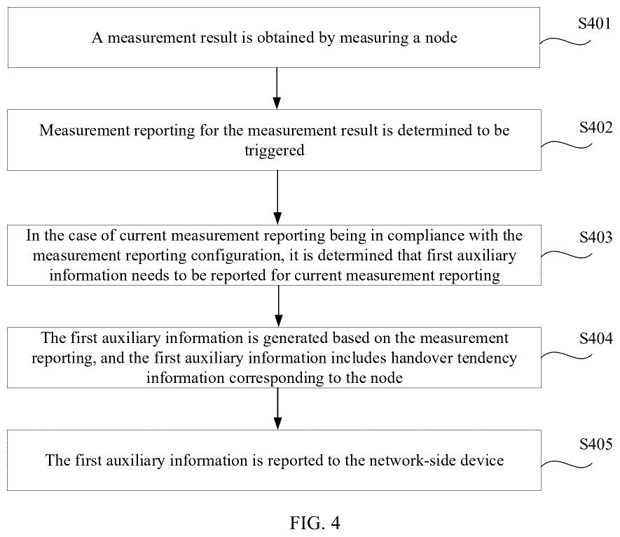

FIG. 4 is a flowchart of an information reporting method according to one or more embodiments of the present disclosure. The method is performed by the user-side device. The reporting permission configuration can include measurement reporting configuration. As shown in FIG. 4, the method includes the following steps.

In step S401, a measurement result is obtained by measuring a node.

In step S402, measurement reporting for the measurement result is determined to be triggered.

In step S403, in the case of current measurement reporting being in compliance with the measurement reporting configuration, it is determined that first auxiliary information needs to be reported for current measurement reporting.

In step S404, the first auxiliary information is generated based on the measurement reporting, and the first auxiliary information includes handover tendency information corresponding to the node.

In step S405, the first auxiliary information is reported to the network-side device.

In some embodiments, the implementations of steps S401, S402, S404, and S405 can refer to embodiments mentioned in the above, which will not be repeated here.

In some embodiments, the measurement reporting configuration can include event triggered reporting. In the case where the current measurement reporting is based on the event triggered reporting, it is determined that the first auxiliary information needs to be reported for the current measurement reporting. The first auxiliary information reported includes the handover tendency information of the node at which the event is triggered. It should be noted that based on the events defined in the above, the occurrence of those events indicates that the measurement result of the serving relay UE or the serving cell is lower than the corresponding threshold, that is, the channel quality between the user-side device and the serving relay UE or the channel quality between the user-side device and the serving cell is poor. Therefore, in order to avoid the interference in the signal transmission of the user-side device, the user-side device can be instructed to perform the handover to the node with better channel quality. Therefore, the first auxiliary information can be reported, to enable the network-side device to quickly configure, based on the handover tendency information in the first auxiliary information, the target node to which the handover is to be performed and/or the time information for initiating the handover to the target node, for the user-side device.

In some embodiments, the measurement reporting configuration can include periodic triggered reporting. In the case where the current measurement reporting is based on the periodic triggered reporting, it is determined that the first auxiliary information needs to be reported for the current measurement reporting. The first auxiliary information reported includes the handover tendency information of the node that is triggered based on a cycle. In this way, the first auxiliary information can be periodically reported to the network-side device, to enable the network-side device to quickly configure, based on the handover tendency information in the first auxiliary information, the target node to which the handover is to be performed and/or the time information for initiating the handover to the target node, for the user-side device.

In some embodiments, the measurement reporting configuration can include the event triggered reporting and the periodic triggered reporting. In the case where the current measurement reporting is based on both the event triggered reporting and the periodic triggered reporting, it is determined that the first auxiliary information needs to be reported for the current measurement reporting.

According to the above embodiments, the measurement reporting configuration can be configured based on the way the measurement reporting is triggered, thereby improving the flexibility of reporting the first auxiliary information.

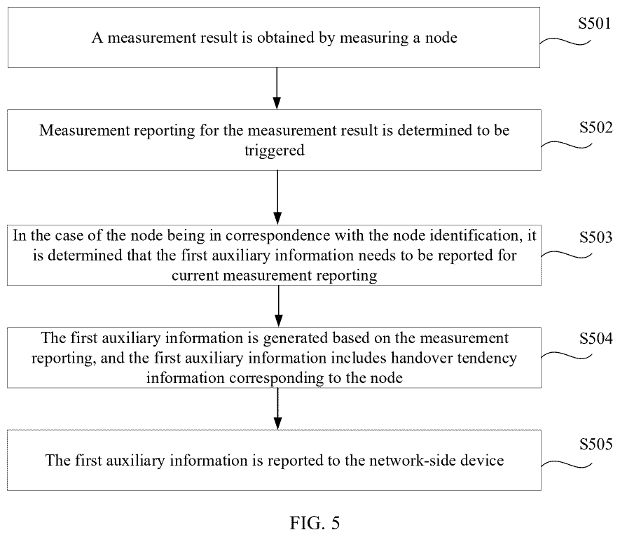

FIG. 5 is a flowchart of an information reporting method according to one or more embodiments of the present disclosure. The method is performed by the user-side device. The reporting permission configuration can include node identification. As shown in FIG. 5, the method includes the following steps.

In step S501, a measurement result is obtained by measuring a node.

In step S502, measurement reporting for the measurement result is determined to be triggered.

In step S503, in the case of the node being in correspondence with the node identification, it is determined that the first auxiliary information needs to be reported for current measurement reporting.

In step S504, the first auxiliary information is generated based on the measurement reporting, and the first auxiliary information includes handover tendency information corresponding to the node.

In step S505, the first auxiliary information is reported to the network-side device.

In some embodiments, the implementations of steps S501, S502, S504, and S505 can refer to embodiments mentioned in the above, which will not be repeated here.

According to the above embodiments, the measurement reporting configuration can be configured based on the node identification, thereby improving the flexibility of reporting the first auxiliary information.

In some embodiments, the reporting permission configuration can be in correspondence with the node, that is, each node can correspond to a reporting permission configuration. For example, for Node A, if the reporting permission configuration is based on the event triggered reporting, then in the case where the current measurement reporting for Node A is performed based on the event triggered reporting, it is determined that the first auxiliary information needs to be reported for the current measurement reporting. That is, the first auxiliary information corresponding to Node A needs to be sent to the network-side device.

According to the above embodiments, different reporting permission configurations can be configured for each node, thereby further improving the flexibility of reporting the first auxiliary information.

In some embodiments, the step S203 shown in FIG. 1 can be achieved through following steps: determining top N nodes with optimal measurement results in the measurement reporting, and generating the first auxiliary information for the N nodes, where N is an integer greater than or equal to 1.

It should be noted that the first auxiliary information generated for the N nodes includes information corresponding to the N nodes (such as the handover tendency information, the node identification, etc.). In some embodiments, the value of N can be configured by the network-side device.

According to the above embodiments, the nodes with better measurement results can be selected, and the first auxiliary information can be generated for these N nodes, which can reduce the resources occupied by sending of the first auxiliary information.

In some embodiments, the step S203 shown in FIG. 1 can be achieved through following steps: determining a node(s) at which the measurement reporting is triggered, and generating the first auxiliary information for the node(s).

According to the above embodiments, the first auxiliary information corresponding to all nodes at which the measurement reporting is triggered can be determined, which can improve the information quantity of the first auxiliary information, to provide reference for the network-side device. The triggered measurement reporting herein can be the periodic triggered measurement reporting or the event triggered measurement reporting.

In some embodiments, the handover tendency information can be generated through a pre-trained model. In some embodiments, the model can be a neural network model, and the model structure of the neural network model can refer to the related art, which will not be repeated here in embodiments of the present disclosure.

In some embodiments, the model can be trained using data related to the handover, to obtain the pre-trained model for generating the handover tendency information. In some embodiments, the data related to the handover is used to construct a training sample, and the training sample is sample data carrying a sample handover tendency label. The predicted handover tendency information is obtained by processing the training sample through the model. The model is iteratively updated using the difference between the predicted handover tendency information and the sample handover tendency label, to obtain the pre-trained model, which is then used for generating the handover tendency information.

In some embodiments, the sample handover tendency label is the same as the handover tendency information in the above embodiments, and can include at least one of the following:
a sample probability label for performing handover to a node, and the sample probability label includes either a sample success probability label or a sample failure probability label;
a sample handover result indication label for performing handover to a node, and the handover result indication label includes either a sample success indication label and a sample failure indication label;
time information label for performing handover to a node, and the time information label is configured to indicate a maximum postpone time label, a minimum postpone time label, or a time range label for initiating the handover to the node.

The explanations of the sample handover tendency label can refer to the relevant descriptions of the handover tendency information mentioned in the above embodiments, which will not be repeated here in embodiments of the present disclosure.

In some embodiments, the data related to the handover can be the node identification of the node, the measurement result of the node, the historical measurement result of the node, and the location information of the user-side device. The measurement result of the node is understood as the measurement result of the current measurement.

In some embodiments, the pre-trained model can be used to generate the handover tendency information, by processing the node identification of the node, the measurement result of the node, the historical measurement result of the node, and the location information of the user-side device through the pre-trained model, and outputting the handover tendency information of the node.

According to embodiments of the present disclosure, it is possible to use the model to quickly and accurately predict the handover tendency information based on the data related to the handover, due to the advantages of fast computing power and robustness of the model.

In some embodiments, in the case where the handover tendency information includes the handover result indication for performing the handover to the node and the output of the model is the probability of performing the handover to the node, the information “the handover result indication for performing the handover to the node” can be obtained by determining the handover result indication for the node based on the probability of performing the handover to the node outputted from the model and a preset probability threshold.

In some embodiments, when the model outputs the failure probability of performing the handover to the node, and when it is determined that the failure probability of performing the handover to the node outputted from the model is greater than a preset failure probability, the handover result indication for the node is determined as the failure indication for performing the handover to the node, where the preset failure probability corresponds to the preset probability threshold.

In some embodiments, when the model outputs the success probability of performing the handover to the node, and when it is determined that the success probability of performing the handover to the node outputted from the model is less than a preset success probability, the handover result indication for the node is determined as the failure indication for performing the handover to the node, where the preset success probability corresponds to the preset probability threshold.

In this way, based on different probabilities of performing the handover to the node outputted by the model and the corresponding preset probability thresholds, it is possible to flexibly determine the handover result indication.

In some embodiments, the preset failure probability and the preset success probability can be determined based on the node and/or the frequency at which the node is located.

In this way, the network-side device can flexibly configure the preset failure probability and the preset success probability corresponding to different nodes, so as to flexibly determine the handover result indication for each node based on the preset failure probability and the preset success probability.

Based on the same inventive concept, embodiments of the present disclosure provide an information receiving method. The method is performed by a network-side device. The method includes receiving first auxiliary information reported by a user-side device, and the first auxiliary information includes handover tendency information corresponding to a node.

In some embodiments, the first auxiliary information and the handover tendency information can refer to embodiments of the information reporting method described in the above, which will not be repeated here.

According to embodiments of the present disclosure, the first auxiliary information includes the handover tendency information configured to indicate achievement of the successful handover, which is reported to the network-side device, so that the network-side device can quickly determine, based on the handover tendency information in the first auxiliary information, the node handover command to be sent to the user-side device, and so that the user-side device can perform the handover according to the node handover command, thereby reducing the failure handover probability when the user-side device performs the handover to the target node and avoiding the failure handover.

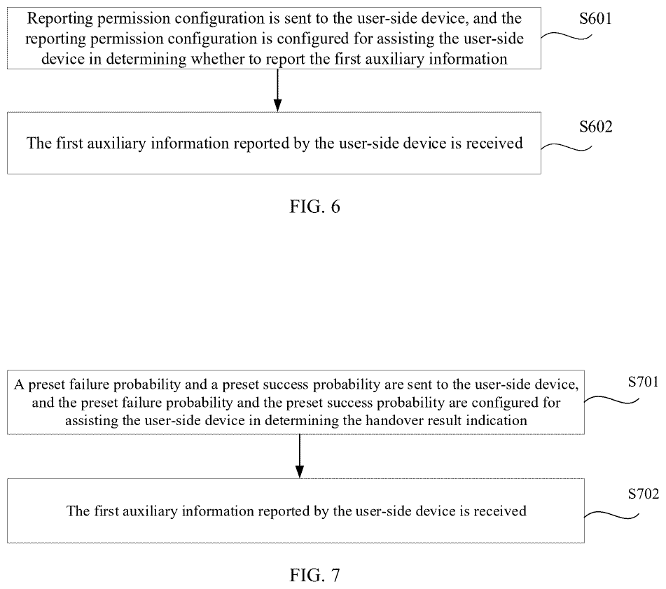

FIG. 6 is a flowchart of an information receiving method according to one or more embodiments of the present disclosure. The method is performed by the network-side device. The method includes the following steps.

In step S601, reporting permission configuration is sent to the user-side device, and the reporting permission configuration is configured for assisting the user-side device in determining whether to report the first auxiliary information.

In step S602, the first auxiliary information reported by the user-side device is received.

In some embodiments, the reporting permission configuration can refer to embodiments of the information reporting method described in the above, which will not be repeated here.

According to the above embodiments, the network-side device can configure, according to actual applications, whether or not the first auxiliary information needs to be reported, thereby improving the flexibility of the user-side device to report the first auxiliary information in different situations.

In some embodiments, the step S602 can be implemented by sending to the user-side device the reporting permission configuration corresponding to the node.

In this way, different reporting permission configurations can be configured for each node, so as to further improve the flexibility of reporting the first auxiliary information.

FIG. 7 is a flowchart of an information receiving method according to one or more embodiments of the present disclosure. The method is performed by the network-side device. The method includes the following steps.

In step S701, a preset failure probability and a preset success probability are sent to the user-side device, and the preset failure probability and the preset success probability are configured for assisting the user-side device in determining the handover result indication.

In step S702, the first auxiliary information reported by the user-side device is received.

According to the above embodiments, the network side can configure the preset failure probability and the preset success probability for the user-side device, so that the user-side device can flexibly determine the handover result indication based on the different probabilities of performing handover to the node outputted by the model and the corresponding preset probability thresholds, thereby obtaining the first auxiliary information including the handover result indication.

In some embodiments, the preset failure probability and the preset success probability correspond to the node and/or the frequency at which the node is located, and thus achieving flexible determination of the handover result indication for each node based on the preset failure probability and the preset success probability.

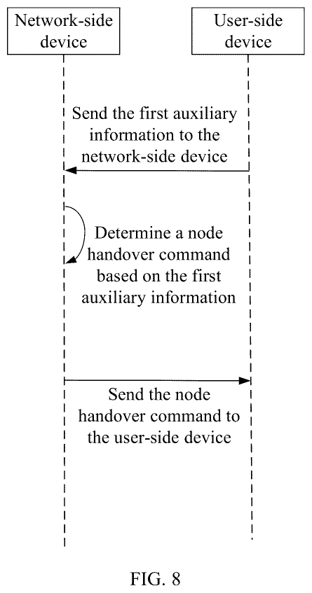

FIG. 8 is a timing diagram of communication between a network-side device and a user-side device according to one or more embodiments of the present disclosure. As shown in FIG. 8, the user-side device sends the first auxiliary information to the network-side device, and the network-side device determines a node handover command based on the first auxiliary information. The network-side device sends the node handover command to the user-side device, so that the user-side device can perform the handover according to the node handover command, reducing the failure probability of the user-side device when initiating the handover to the target node and avoiding the failure handover.

In some embodiments, the implementations of the steps shown in FIG. 8 can refer to the relevant embodiments explained in the above, which will not be repeated here in embodiments of the present disclosure.

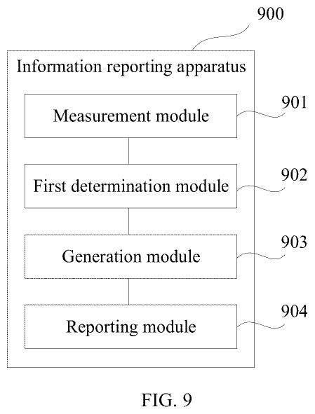

Based on the same inventive concept, embodiments of the present disclosure provide an information reporting apparatus. FIG. 9 is a block diagram of an information reporting apparatus according to one or more embodiments of the present disclosure. As shown in FIG. 9, the information reporting apparatus 900 includes a measurement module 901, a first determination module 902, a generation module 903, a reporting module 904.

The measurement module 901 is configured to obtain a measurement result by measuring a node.

The first determination module 902 is configured to determine to trigger measurement reporting for the measurement result.

The generation module 903 is configured to generate first auxiliary information based on the measurement reporting, and the first auxiliary information includes handover tendency information corresponding to the node.

The reporting module 904 is configured to report the first auxiliary information to the network-side device.

In some embodiments, the node includes a cell and/or a relay UE.

In some embodiments, the apparatus 900 further includes a second determination module.

The second determination module is configured to determine, based on a reporting permission configuration pre-obtained by the user-side device, that the first auxiliary information needs to be reported for current measurement reporting before generating the first auxiliary information based on the measurement reporting.

In some embodiments, the reporting permission configuration includes a measurement reporting configuration and/or node identification. The second determination module is configured to:
if the current measurement reporting is in compliance with the measurement reporting configuration, determine that the first auxiliary information needs to be reported for the current measurement reporting; and/or
if it is determined that the node is in correspondence with the node identification, determine that the first auxiliary information needs to be reported for the current measurement reporting.

In some embodiments, the measurement reporting configuration includes event triggered reporting and/or periodic triggered reporting.

In some embodiments, the reporting permission configuration is sent from the network-side device to the user-side device.

In some embodiments, the reporting permission configuration corresponds to the node.

In some embodiments, the generation module 903 is configured to: determine top N nodes with optimal measurement results in the measurement reporting, and generate the first auxiliary information for the N nodes; or determine the node(s) at which the measurement reporting is triggered and generate the first auxiliary information for the node(s).

In some embodiments, the handover tendency information includes at least one of the following:
a probability of performing handover to the node, and the probability includes either a success probability or a failure probability;
a handover result indication for performing handover to the node, and the handover result indication includes either a success indication or a failure indication;
time information about performing handover to the node, and the time information is configured to indicate a maximum postpone time, a minimum postpone time, or a time range for initiating the handover to the node.

In some embodiments, the handover tendency information is generated through a pre-trained model.

In some embodiments, the generation module 903 is configured to use the pre-trained model to generate the handover tendency information by:
processing node identification of the node, the measurement result of the node, a historical measurement result of the node, and location information of the user-side device through the pre-trained model; and outputting the handover tendency information about the node.

In some embodiments, in the case where the handover tendency information includes the handover result indication for performing the handover to the node and the output of the model is the probability of performing the handover to the node, the apparatus further includes a third determination module.

The third determination module is configured to determine the handover result indication for the node based on the probability of performing the handover to the node outputted by the model and a preset probability threshold.

In some embodiments, the third determination module is configured to:
determine, in response of determination that the failure probability of performing the handover to the node outputted by the model being greater than a preset failure probability, that the handover result indication for the node is the failure indication for performing the handover to the node;
determine, in response of determination that the success probability of performing the handover to the node outputted by the model being less than a preset success probability, that the handover result indication for the node is the failure indication for performing the handover to the node.

In some embodiments, the preset failure probability and the preset success probability are determined based on the node and/or the frequency at which the node is located.

The specific ways in which each module of the apparatus in the above embodiments performs its operations have been described in detail in the embodiments related to the information reporting methods, and will not be elaborated here.

Based on the same inventive concept, embodiments of the present disclosure provide an information receiving apparatus applied to the network-side device. The information receiving apparatus includes a receiving module.

The receiving module is configured to receive first auxiliary information reported by a user-side device, and the first auxiliary information includes handover tendency information corresponding to a node.

In some embodiments, the apparatus further includes a first sending module.

The first sending module is configured to send a reporting permission configuration to the user-side device before receiving the first auxiliary information reported by the user-side device. The reporting permission configuration is configured for assisting the user-side device in determining whether to report the first auxiliary information.

In some embodiments, the first sending module is configured to send a reporting permission configuration corresponding to the node to the user-side device.

In some embodiments, the handover tendency information includes at least one of the following:
a probability of performing handover to the node, and the probability includes either a success probability or a failure probability;
a handover result indication for performing handover to the node, and the handover result indication includes either a success indication or a failure indication;
time information about performing handover to the node, and the time information is configured to indicate a maximum postpone time, a minimum postpone time, or a time range for initiating the handover to the node.

In some embodiments, the apparatus further includes a second sending module.

The second sending module is configured to send a preset failure probability and a preset success probability to the user-side device, and the preset failure probability and the preset success probability are configured for assisting the user-side device in determining the handover result indication.

In some embodiments, the preset failure probability and the preset success probability correspond to the node and/or the frequency at which the node is located.

The specific ways in which each module of the apparatus in the above embodiments performs its operations have been described in detail in the embodiments related to the information receiving methods, and will not be elaborated here.

Based on the same inventive concept, embodiments of the present disclosure provide a non-transitory computer storage medium, which stores executable instructions. When the executable instructions are executed by a third processor, any of information reporting methods or information receiving methods as described above is performed.

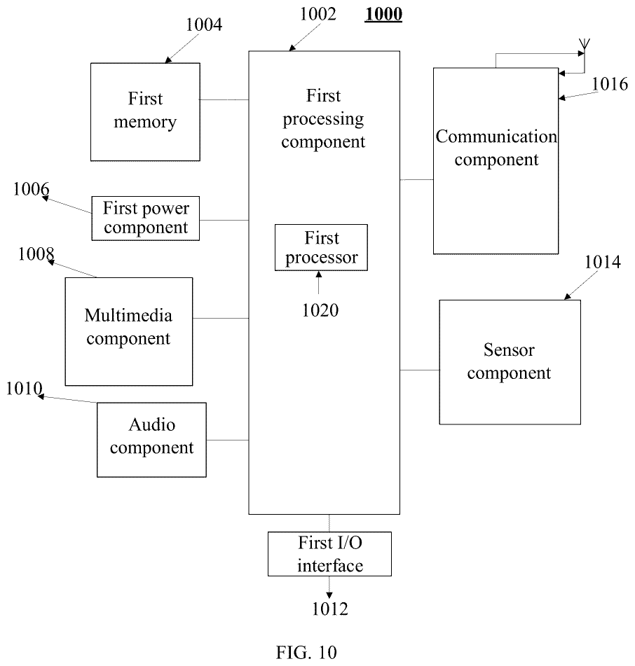

FIG. 10 is a schematic diagram of a structure of a user-side device according to one or more embodiments of the present disclosure. For example, the user-side device 1000 can be a mobile phone, a computer, a digital broadcasting user device, a messaging device, a game console, a tablet device, a medical device, a fitness device, a personal digital assistant, etc.

As shown in FIG. 10, the user-side device 1000 can include one or more following components: a first processing component 1002, a first memory 1004, a first power component 1006, a multimedia component 1008, an audio component 1010, a first input/output (I/O) interface 1012, a sensor component 1014, and a communication component 1016.

The first processing component 1002 typically controls the overall operation of the user-side device 1000, such as operations associated with display, telephone call, data communication, camera operation, and recording operations. The first processing component 1002 can include one or more processors to execute instructions to complete all or part of the above information reporting methods performed by the user-side device. In addition, the first processing component 1002 can include one or more modules to facilitate interactions between the first processing component 1002 and other components. For example, the first processing component 1002 can include a multimedia module to facilitate the interaction between the multimedia component 1008 and the first processing component 1002.

The first memory 1004 is configured to store various types of data to support operations on the user-side device 1000. Examples of such data include instructions, contact data, phone book data, messages, pictures, videos, and the like for any application or method operating on the user-side device 1000. The first memory 1004 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The first power component 1006 provides power for various components of the user-side device 1000. The first power component 1006 can include a power management system, one or more power supplies, and other components associated with generating, managing, and distributing power for the user-side device 1000.

The multimedia component 1008 includes a display screen providing an output interface between the user-side device 1000 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 1008 includes a front camera and/or a rear camera. When the user-side device 1000 is in operation mode, such as shooting mode or video mode, the front camera and/or rear camera can receive external multimedia data. Each front camera and rear camera can be a fixed optical lens system or have focal length and optical zoom capability.

The audio component 1010 is configured to output and/or input audio signals. For example, the audio component 1010 includes a microphone (MIC), which is configured to receive an external audio signal when the user-side device 1000 is in an operation mode, such as a calling mode, a recording mode, and a voice recognition mode. The received audio signal may be further stored in first memory 1004 or transmitted via communication component 1016. In some embodiments, the audio component 1010 also includes a speaker for outputting audio signals.

The first I/O interface 1012 provides an interface between the first processing component 1002 and peripheral interface modules, which can be a keyboard, a click wheel, a button, etc. These buttons may include, but are not limited to, the Home button, Volume button, Start button, and Lock button.

The sensor component 1014 includes one or more sensors for providing various aspects of condition evaluation for the user-side device 1000. For example, the sensor component 1014 can detect an open/closed state of the user-side device 1000, relative positioning of the components. The component is, for example, a display and a keypad of the user-side device 1000. The sensor component 1014 can also detect changes in the position of the user-side device 1000 or one component of the user-side device 1000, presence or absence of the user's contact with the user-side device 1000, orientation or acceleration/deceleration of the user-side device 1000 and temperature change of the user-side device 1000. The sensor component 1014 may include a proximity sensor configured to detect the presence of nearby objects without any physical contact. The sensor component 1014 may also include a light sensor, such as a CMOS or CCD image sensor, for use in imaging applications. In some embodiments, the sensor component 1014 may also include an acceleration sensor, a gyroscope sensor, a magnetic sensor, a pressure sensor, or a temperature sensor.

The communication component 1016 is configured to facilitate wired or wireless communication between the user-side device 1000 and other devices. The user-side device 1000 can access wireless networks based on communication standards, such as WiFi, 4G or 5G, or a combination thereof. In some embodiments, the communication component 1016 receives a broadcast signal or broadcast related information from an external broadcast management system via a broadcast channel. In some embodiments, the communication component 1016 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the user-side device 1000 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing above information reporting methods performed by the user-side device.

In some embodiments, a non-transitory computer-readable storage medium including instructions is also provided, such as a first memory 1004 including instructions, which can be executed by the first processor 1020 of the user-side device 1000 to complete the above information reporting methods performed by the user-side device. For example, the non-transitory computer-readable storage medium can be ROM, random access memory (RAM), CD-ROM, tapes, floppy disks, optical data storage devices, etc.

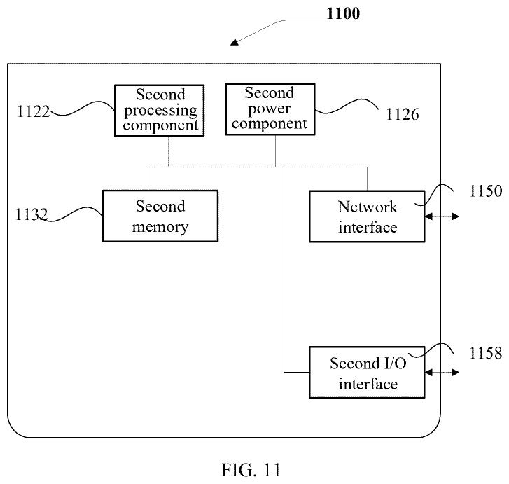

FIG. 11 is a schematic diagram of a structure of a network-side device according to one or more embodiments of the present disclosure. For example, the network-side device 1100 can be provided as a base station. As shown in FIG. 11, the network-side device 1100 includes a second processing component 1122, which further includes one or more second processors, and a second memory 1132, which represents the memory resources and is configured for storing instructions that can be executed by the second processing component 1122, such as application programs. The application programs stored in the second memory 1132 may include one or more modules each corresponding to a set of instructions. In addition, the second processing component 1122 is configured to execute the instructions to perform the information receiving methods performed by the network-side device described in the above.

The network-side device 1100 may also include a second power component 1126 configured to perform the power management for the network-side device 1100, a wired or wireless network interface 1150 configured to connect the network-side device 1100 to the network, and a second input/output interface 1158. The network-side device 1100 can be operated based on an operating system stored in the second memory 1132, such as Windows Server™, Mac OS X™, Unix™, Linux™, FreeBSD™, or similar operating systems.

In some embodiments, a non-transitory computer-readable storage medium including instructions is also provided, such as a second memory 1132 including instructions, which can be executed by the second processor of the network-side device 1100 to complete the above information receiving methods performed by the network-side device 1100. For example, the non-transitory computer-readable storage medium can be ROM, random access memory (RAM), CD-ROM, tapes, floppy disks, optical data storage devices, etc.

In some embodiments, a computer program product is also provided. The computer program product includes a computer program executable by a programmable device, the computer program having code portions for performing the information reporting methods on the user device side or the information receiving methods on the network device side when executed by the programmable device.

After considering the specification and practices of the invention disclosed herein, those skilled in the art will easily come up with other implementation solutions of the present disclosure. The present disclosure intends to cover any variations, uses, or adaptive changes of the present disclosure, which follow the general principles of the present disclosure and include common knowledge or commonly used technical means in the art that are not disclosed in the present disclosure. The specification and embodiments are only considered as exemplary, and the true scope and spirit of the present disclosure are defined by appended claims.

It should be understood that embodiments of the present disclosure are not limited to the precise structure described in the above and shown in the drawings, and various modifications and changes can be made without departing from its scope. The scope of the present disclosure is limited only by the appended claims.

1. An information reporting method, performed by a user-side device, the method comprising:
obtaining a measurement result by measuring a node;
determining to trigger measurement reporting for the measurement result;
generating first auxiliary information based on the measurement reporting, wherein the first auxiliary information comprises handover tendency information corresponding to the node; and
reporting the first auxiliary information to a network-side device.

2. The method according to claim 1, wherein the node comprises at least one of a cell or a relay user equipment (UE).

3. The method according to claim 1, further comprising:
determining, before generating the first auxiliary information based on the measurement reporting and based on a reporting permission configuration pre-obtained by the user-side device, that the first auxiliary information needs to be reported for the measurement reporting.

4. The method according to claim 3, wherein the reporting permission configuration comprises at least one of a measurement reporting configuration or node identification; and
wherein determining, based on the reporting permission configuration pre-obtained by the user-side device, that the first auxiliary information needs to be reported for the measurement reporting, comprises at least one of:
determining, in case of the measurement reporting being in compliance with the measurement reporting configuration, that the first auxiliary information needs to be reported for the measurement reporting; or
determining, in case of the node being in correspondence with the node identification, that the first auxiliary information needs to be reported for the measurement reporting.

5. The method according to claim 4, wherein the measurement reporting configuration comprises at least one of event triggered reporting or periodic triggered reporting.

6. The method according to claim 3, wherein the reporting permission configuration is sent from the network-side device to the user-side device, and the reporting permission configuration corresponds to the node.

7. (canceled)

8. The method according to claim 1, wherein generating the first auxiliary information based on the measurement reporting, comprises:
determining at least one node of nodes at which the measurement reporting is triggered and generating the first auxiliary information for the at least one node;
wherein the at least one node comprises top N nodes with optimal measurement results in the measurement reporting, where N is an integer greater than or equal to 1.

9. The method according to claim 1, wherein the handover tendency information comprises at least one of:
a probability of performing handover to the node, wherein the probability comprises one of a success probability and a failure probability;
a handover result indication for performing the handover to the node, wherein the handover result indication comprises one of a success indication and a failure indication; or
time information about performing the handover to the node, wherein the time information is configured to indicate a maximum postpone time, a minimum postpone time, or a time range, for initiating the handover to the node.

10. The method according to claim 9, wherein generating the handover tendency information through a pre-trained model, and generating the handover tendency information through the pre-trained model comprises:
processing node identification of the node, the measurement result of the node, a historical measurement result of the node, and location information of the user-side device through the pre-trained model; and
outputting the handover tendency information about the node.

11. (canceled)

12. The method according to claim 10, further comprising:
determining the handover result indication for the node based on the probability of performing the handover to the node outputted by the model and a preset probability threshold, wherein the handover tendency information comprises the handover result indication for performing the handover to the node and an output of the model is the probability of performing the handover to the node.

13. The method according to claim 12, wherein determining the handover result indication for the node based on the probability of performing the handover to the node outputted by the model and the preset probability threshold, comprises:
determining, in response of determination that the failure probability of performing the handover to the node outputted by the model being greater than a preset failure probability, that the handover result indication for the node is the failure indication for performing the handover to the node; and
determining, in response of determination that the success probability of performing the handover to the node outputted by the model being less than a preset success probability, that the handover result indication for the node is the failure indication for performing the handover to the node.

14. The method according to claim 13, wherein the preset failure probability and the preset success probability are determined based on at least one of the node or a frequency at which the node is located.

15. An information receiving method, performed by a network-side device, the method comprising:
receiving first auxiliary information reported by a user-side device, wherein the first auxiliary information comprises handover tendency information corresponding to a node.

16. The method according to claim 15, further comprising:
sending a reporting permission configuration to the user-side device before receiving the first auxiliary information reported by the user-side device, wherein the reporting permission configuration is configured for assisting the user-side device in determining whether to report the first auxiliary information.

17. The method according to claim 15, wherein sending the reporting permission configuration to the user-side device, comprises:
sending the reporting permission configuration corresponding to the node to the user-side device.

18. The method according to claim 15, wherein the handover tendency information comprises at least one of:
a probability of performing handover to the node, wherein the probability comprises one of a success probability and a failure probability;
a handover result indication for performing the handover to the node, wherein the handover result indication comprises one of a success indication and a failure indication; or
time information about performing the handover to the node, wherein the time information is configured to indicate a maximum postpone time, a minimum postpone time, or a time range, for initiating the handover to the node.

19. The method according to claim 18, further comprising:
sending a preset failure probability and a preset success probability to the user-side device, wherein the preset failure probability and the preset success probability are configured for assisting the user-side device in determining the handover result indication.

20. The method according to claim 19, wherein the preset failure probability and the preset success probability are determined based on at least one of the node or a frequency at which the node is located.

21-22. (canceled)

23. A user-side device, comprising:
a first processor; and
a first memory for storing executable instructions to be executed by the first processor;
wherein the first processor is configured to execute the executable instructions to perform the method according to claim 1.

24. A network-side device, comprising:
a second processor; and
a second memory for storing executable instructions to be executed by the second processor;
wherein the second processor is configured to execute the executable instructions to perform the method according to claim 15.

25. (canceled)
